(19) United States
(12) Patent Application Publication
(10) Pub. No.: US 2025/0055003 A1
(43) Pub. Date: Feb. 13, 2025

(54) PROTECTED MEMBRANE ELECTRODE ASSEMBLY FOR FUEL CELL

(71) Applicant: GM GLOBAL TECHNOLOGY OPERATIONS LLC, Detroit, MI (US)

(72) Inventors: Burl B. Keel, IV, Waterford, MI (US); Thomas D. Bronchetti, Auburn Hills, MI (US); Swaminatha P. Kumaraguru, Rochester Hills, MI (US)

(73) Assignee: GM GLOBAL TECHNOLOGY OPERATIONS LLC, Detroit, MI (US)

(21) Appl. No.: 18/366,016

(22) Filed: Aug. 7, 2023

(51) Int. Cl. H01M 8/0276; H01M 4/88; H01M 8/1004

(52) U.S. Cl. CPC H01M 8/0276; H01M 4/8807; H01M 8/1004

(57) ABSTRACT

A membrane electrode assembly (MEA) for a fuel cell. The MEA may include a first gas diffusion electrode (GDE) layer, a second GDE layer, a subgasket, and a membrane sandwiched between first and second GDE layers. The MEA may further include a protective barrier configured for protecting the membrane against external contaminants. The protective barrier may be configured surrounding a perimeter of the membrane between the surrounding subgasket portion and the second GDE layer.

### INTRODUCTION

The present disclosure relates to protecting a membrane electrode assembly (MEA) from external contaminants, such as but not necessarily limited to protecting an MEA employed within a gas diffusion electrode (GDE) fuel cell architecture.

In a GDE architecture, an unprotected membrane may include an edge, a perimeter, or other surface exposed to external contaminations. The exposure may occur between GDE layers to an extent that a pathway may be created for life limiting contaminants like cations to reach and react with the membrane. One reaction of concern that may result from Fe2+ ions to entering or interacting with the membrane in such a manner as to work against and potentially breakdown the chemical structure of the membrane over time.

### SUMMARY

One non-limiting aspect of the present disclosure relates to protecting a membrane from contaminates, such as with a protected membrane electrode assembly (MEA) having a protective barrier configured for protecting the membrane against external contaminants. The protected MEA may be configured for use with a wide variety of gas diffusion electrode (GDE) architectures, including but not limited to those employed within a fuel cell to provide electrical power to a motor use for propelling a vehicle.

One non-limiting aspect of the present disclosure relates to a protected membrane electrode assembly (MEA) for a fuel cell. The protected MEA may include an anode gas diffusion electrode (GDE) layer having an anode top face and an anode bottom face, a cathode GDE layer having a cathode top face and a cathode bottom face, a membrane having a membrane top face and a membrane bottom face with the membrane bottom face attached to the cathode top face, a subgasket having a subgasket top face and a subgasket bottom face with the subgasket bottom face attached to the membrane top face and the subgasket top face attached to the anode bottom face, and a protective barrier configured for protecting the membrane against external contaminants. The protective barrier may surround a perimeter of the membrane between the subgasket bottom face and the cathode top face.

The protected MEA may include a side perimeter portion of the cathode GDE layer forming at least a portion of the protective barrier.

The protected MEA may include the side perimeter portion being bent upwardly relative to an inner portion of the cathode GDE layer such that the side perimeter portion presses against the subgasket bottom face.

The protected MEA may include the side perimeter portion may be formed by removing a segment of the membrane after the membrane has been attached to the cathode GDE layer.

The protected MEA may include the segment being removed from the membrane as part of a laser ablation process.

The protected MEA may include the segment being removed from the membrane as part of a die cutting process.

The protected MEA may include a side perimeter portion of the membrane forming at least a portion of the protective barrier.

The protected MEA may include the side perimeter portion corresponding with an outer band of the membrane offset with a channel from an inner portion of the membrane.

The protected MEA may include the channel being devoid of a material comprising the membrane.

The protected MEA may include the channel being formed by removing a segment of the membrane after the membrane has been attached to the cathode GDE layer.

The protected MEA may include the segment being removed from the membrane as part of a laser ablation process or a die cutting process.

One non-limiting aspect of the present disclosure relates to a method for manufacturing a protected membrane electrode assembly (MEA) for a fuel cell. The method may include receiving an anode gas diffusion electrode (GDE) layer having an anode top face and an anode bottom face, receiving a cathode GDE layer having a cathode top face and a cathode bottom face, receiving a membrane having a membrane top face and a membrane bottom face, receiving a subgasket having a subgasket top face and a subgasket bottom face, removing a membrane portion of the membrane to provide a protective barrier for protecting the membrane against external contaminant, adhering the anode bottom face to the subgasket top face and the membrane top face, and adhering the subgasket bottom face to the membrane top face such that the protective barrier surrounds a perimeter of the membrane between the subgasket bottom face and the cathode top face.

The method may include providing the protective barrier based at least in part on bending a cathode portion of the cathode GDE layer coinciding with the membrane portion upwardly relative to an inner portion of the cathode GDE layer such that at least part of the cathode portion presses against the subgasket bottom face.

The method may include providing the protective barrier based at least in part on removing the membrane portion such that the membrane is divided into an outer membrane band and an inner membrane portion, the outer membrane band surrounding the inner membrane portion and being offset therefrom with a channel.

The method may include removing the membrane portion after the membrane bottom face has been adhered to the cathode top face.

The method may include removing the membrane portion prior to the membrane bottom face being adhered to the cathode top face.

One non-limiting aspect of the present disclosure relates to a protected membrane electrode assembly (MEA) for a fuel cell. The protected MEA may include a first gas diffusion electrode (GDE) layer, a second GDE layer, a subgasket, a membrane sandwiched between first and second GDE layers and at least a surrounding subgasket portion of the subgasket, and a protective barrier configured for protecting the membrane against external contaminants. The protective barrier may surround a perimeter of the membrane between the surrounding subgasket portion and the second GDE layer.

The protected MEA may include the protective barrier being formed with a bent portion of the second GDE layer.

The protected MEA may include the protective barrier being formed with a channel shaped to divide the membrane into an outer membrane band and an inner membrane portion.

The protected MEA may include the protective barrier being formed by removing a portion of the membrane.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a schematic view of a vehicle in accordance with one non-limiting aspect of the present disclosure.

FIG. 2 illustrates a schematic view of a fuel cell system in accordance with one non-limiting aspect of the present disclosure.

FIG. 3 illustrates a MEA manufacturing system in accordance with one non-limiting aspect of the present disclosure.

FIG. 4 illustrates a cross-sectional view of an assembled MEA in accordance with one non-limiting aspect of the present disclosure.

FIG. 5 illustrates a cross-sectional view of a protected MEA in accordance with one non-limiting aspect of the present disclosure.

FIG. 6 illustrates another MEA manufacturing system in accordance with one non-limiting aspect of the present disclosure.

FIG. 7 illustrates a cross-sectional view of another assembled MEA in accordance with one non-limiting aspect of the present disclosure.

### DETAILED DESCRIPTION

As required, detailed embodiments of the present disclosure may be disclosed herein; however, it may be to be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may be not to be interpreted as limiting, but merely as a representative basis for teaching one skilled in the art to variously employ the present disclosure.

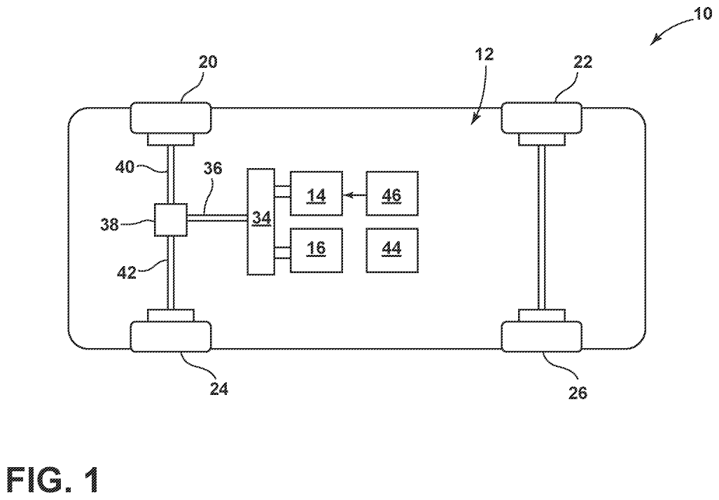

FIG. 1 illustrates a schematic view of a vehicle 10 in accordance with one non-limiting aspect of the present disclosure. The vehicle 10 may be configured with a propulsion system, powertrain, or other drivetrain 12 having an electric motor 14 or other electrically driven device operable for propelling or otherwise driving the vehicle 10. The vehicle 10 may be illustrated for exemplary non-limiting purposes as being of a hybrid type due to the powertrain 12 optionally including an internal combustion engine (ICE) 16. The ICE 16 and the electric motor 14, or other device configured to convert electrical power to mechanical power, may cooperate to provide rotational force/torque to one or more of a plurality of wheels 20, 22, 24, 26. The powertrain 12 may include a transmission 34, a driveshaft 36, a differential 38, axles 40, 42, and/or other componentry to facilitate conveying rotative force from the ICE 16 and/or the motor 14 to the wheels 20, 22, 24, 26. The vehicle 10 may be shown to include the powertrain 12 configured to connect the ICE 16 and the motor 14 to the front wheels 20, 24 for non-limiting purposes as the present disclosure fully contemplates its use and application with four-wheel drive automobiles and other, non-automobile types of vehicles. A controller 44 may be configured to generate control signals associated with directing and otherwise implementing desired control of the powertrain 12, the motor 14, the ICE 16, and/or other features of the vehicle 10.

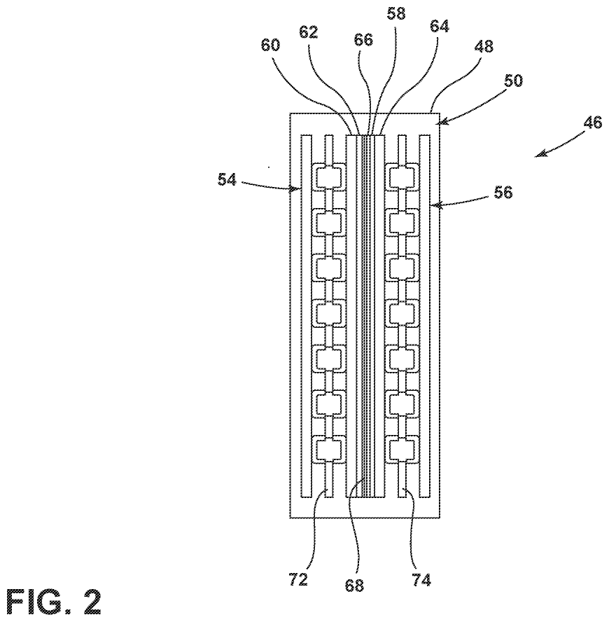

The vehicle 10 may be presented for non-limiting purposes as being representative of a wide variety of vehicles and/or other devices that may rely on converting electrical power to mechanical power. Such vehicles may be generically referred to as electric vehicles and include a wide range of capabilities for supporting the conversion of electrical power to mechanical power. The vehicle 10 may be contemplated to include differing configurations for generating, storing, and supplying electrical power to the electric motor 14 and/or other devices or system onboard the vehicle 10. One non-limiting aspect of the present disclosure relates to the electrical power being provided at least based in part on electrical power derived from a fuel cell system 46. The fuel cell system 46 may be configured to generate electrical power by relying at least partially upon electrochemical reactions of the type suitable for generating electrical power. FIG. 2 illustrates a schematic view of the fuel cell system 46 in accordance with one non-limiting aspect of the present disclosure. The system 46 may include one or more fuel cell stacks 48, each of which may be composed of multiple fuel cells 50, such as of a polymer electrolyte membrane (PEM) fuel cells (PEMFC) type that may be stacked and connected in electrical series or parallel with one another. Each fuel cell 50 may be a multi-layer construction with an anode side 54 and a cathode side 56 that may be separated by a proton-conductive membrane 58, which may be referred to herein as the membrane 58.

An anode gas diffusion electrode (GDE) layer 60 may be provided on the anode side 54 of the PEMFC with an anode catalyst layer 62 mounted thereto or interposed between for operatively connecting the membrane 58 and corresponding GDE layer 60. Juxtaposed in opposing spaced relation to the anode layers 60 and 62 may be a cathode GDE layer 64, which may be provided on the cathode side 56 of the membrane 48. A cathode catalyst layer 66 may be mounted onto the GDE layer 64 or interposed between and operatively connecting the membrane 58 and corresponding GDE layer 64. The two GDE layers 60 and 64, two catalyst layers 56 and 66, and subgaskets 68 cooperate with the membrane 58 to define, in whole or in part, a membrane electrode assembly (MEA) 70. The GDE layers 60 and 64 may be porous constructions that provide for fluid inlet transport to and fluid exhaust transport from the MEA 70. An anode flow field plate 72 (with optional bipolar plate) may be provided on the anode side 54 in abutting relation to the anode GDE layer 60. A cathode flow field plate 74 (with optional bipolar plate (BPP)) may be provided on the cathode side 56 in abutting relation to the cathode GDE layer 64.

Coolant flow channels may be configured to traverse each of the plates 72 and 74 to allow cooling fluid to flow through the fuel cell 50. Fluid inlet ports and headers may direct a hydrogen-rich fuel and an oxidizing agent to respective passages in the anode and cathode flow field plates 72, 74. A central active region of the anode's flow field plate 72 that faces the proton-conductive membrane 58 may be fabricated with an anode flow field composed of serpentine flow channels for distributing hydrogen over an opposing face of the GDE layer 60 and membrane 58. The MEA 70 and flow field plates 72, 74 may be stacked together between current collector plates and monopolar end plates (not shown). The fuel cell system 46 may also employ anode recirculation where an anode recirculation gas may be fed from an exhaust manifold or headers through an anode recirculation line for recycling hydrogen back to the anode side 54 input so as to conserve hydrogen gas in the stack 48. Hydrogen (H2) inlet flow—be it gaseous, concentrated, entrained, or otherwise—may be transmitted from a hydrogen source, such as fuel storage tank 46, to the anode side 54 of the fuel cell stack 48 via a fluid injector 47 coupled to a (first) fluid intake conduit or hose.

The fuel cell stack 48 may be of the type commonly employed in automotive related applications, such as but not necessarily limited to a fuel cell stack 48 that may utilize a solid polymer electrolyte membrane (PEM)—also referred to as a “proton exchange membrane” (PEM)—to facilitate the electrolysis process by providing an ion transport between an anode and a cathode. Proton exchange membrane fuel cells (PEMFC) may employ a solid polymer electrolyte (SPE) proton-conducting membrane, such as a perfluorosulfonic acid membrane. The anode and cathode (not shown in detail) of the fuel cell stack 48 may include dispersed catalytic particles, such as platinum, supported on carbon particles and mixed with an ionomer. This catalytic mixture may be deposited on the sides of the membrane to form anode and cathode layers. The combination of the anode catalytic layer, cathode catalytic layer, and electrolyte membrane may define MEA 58 in which the anode catalyst and cathode catalyst may be supported on opposite faces of the ion conductive solid polymer membrane. To avoid Fe2+ ions and/or other external contaminants entering or interacting with the membrane in such a manner as to work against and potentially breakdown the chemical structure of the membrane over time, one non-hunting aspect of the present disclosure contemplates protecting the MEA.

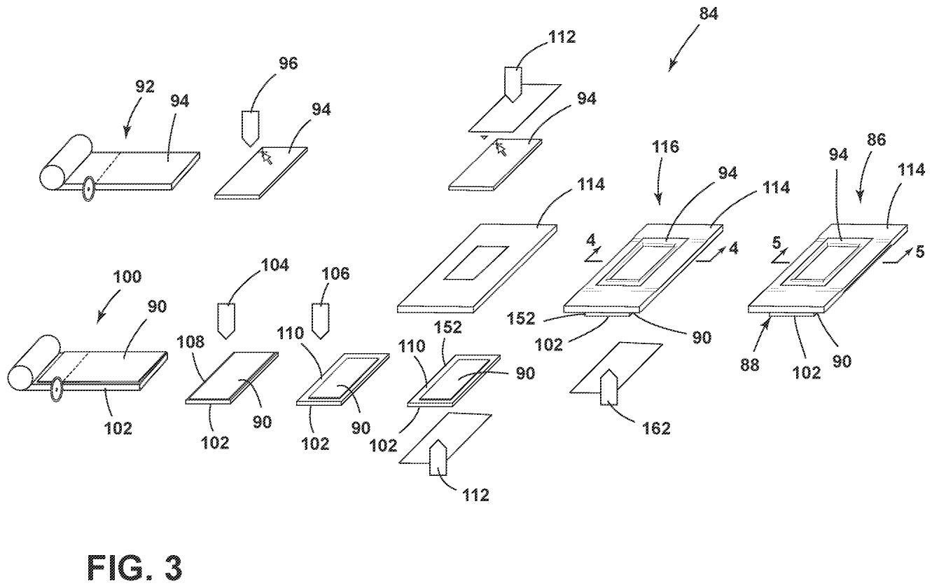

FIG. 3 schematically illustrates a MEA manufacturing system 84 in accordance with one non-limiting aspect of the present disclosure. The MEA manufacturing system 84 may be configured for manufacturing an MEA 86 with a protective barrier 88. The protective barrier 88 may be used to protect the MEA 86 whereby the protective barrier 88 may be operable to prevent, minimize, thwart, or otherwise limit the exposure of a membrane 90 to external contaminants. The protective barrier 88, for example, may be used in the described manner to limit the likelihood or possibility of Fe2+ ions and/or other external contaminants entering or interacting with the membrane 90 in such a manner as to work against and potentially breakdown the chemical structure of the membrane 90 over time. The protected MEA 86 may be configured for use with a wide variety of GDE and non-GDE architectures, including but not limited to those employed within other devices, vehicles, etc. such that the present disclosure fully contemplates the protected MEA 86 being operable within other environments in addition to the fuel cell 48 and/or fuel cell system 46 described above. The protected MEA 86 is described with respect to the fuel cell system 46 in order to demonstrate advantageous capabilities of the protected MEA 86 to guard against the membrane 90 being influenced with external contaminants that may be particularly prevalent within an operating setting of the vehicle 10.

The MEA manufacturing system 84 may include an anode spool 92 having a supply of material suitable for forming an anode GDE layer 94. The anode GDE layer 94 may be generated based in part on a cutting, separating, extracting, or otherwise recovering the anode GDE layer 94 from the anode spool 92. This is illustrated for non-limiting purposes with respect to a stamping, laser, or die cutting tool or operation 96 being operable to cut the anode GDE layer 94 to a desired shape and configuration once unwound from the anode spool 92. Alternatively, the anode GDE layer 94 may be provided through other mechanisms and/or as an already cut-to-shape component having the desired shape, size, configuration, etc. The protected MEA 86 manufacturing system may include a cathode spool 100 having a supply of material suitable for forming a cathode GDE layer 102, which is shown to include a membrane 90 integrated therewith, i.e., included as part of the material supplied with the cathode spool 100. The cathode GDE layer 102 and the membrane 90 may be generated based in part on cutting, separating, extracting, or recovering the cathode GDE layer 102 from the cathode spool 100. This is illustrated for non-purposes with respect to a stamping, laser, or die cutting tool or operation 104 being operable to commonly cut the cathode GDE layer 102 and the membrane 90 to a desired shape and configuration once unwound from the cathode spool 100. Alternatively, the cathode GDE layer 102 may be provided through other mechanisms, the membrane 90 layer may be separately spooled or supplied, and/or the cathode layer and/or the membrane 90 may be received as already cut-to-shape component(s) having the desired shape, size, configuration, etc.

Once the anode GDE layer 94, the cathode GDE layer 102, and the membrane 90 may be cut to size, the MEA manufacturing system 84 may include a protective barrier tool 106 operable for executing a barrier protection process whereby part of the protective barrier 88 may be added. In the illustrated configuration, the protective barrier 88 may be added by removing a membrane portion 108 of the membrane 90, i.e., the protected barrier 88 may correspond with a portion 110 of the cathode GDE layer 102 coinciding with the membrane portion 108 removed from the membrane 90. The protective barrier tool 106, for example, may be configured to support a laser ablation process, a die cutting process, or other removal process suitable for removing the membrane portion 108 from the membrane 90 adhered to the cathode GDE layer 102. The membrane portion 108 removed from the membrane 90 may result in the membrane 90 having a smaller footprint than prior to the removal process. The MEA manufacturing system 84 may include an assembly process 112 for assembling the cathode GDE layer 102, the membrane 90, a subgasket 114, and the anode GDE layer 94 together. The subgasket 114 may be used to provide sealing and other protective measures for the membrane 90 and may be provided from a spool (not shown), or other mechanism, e.g., as a cut-to-size piece. A resulting, assembled MEA 116 may be provided following the assembly process 112.

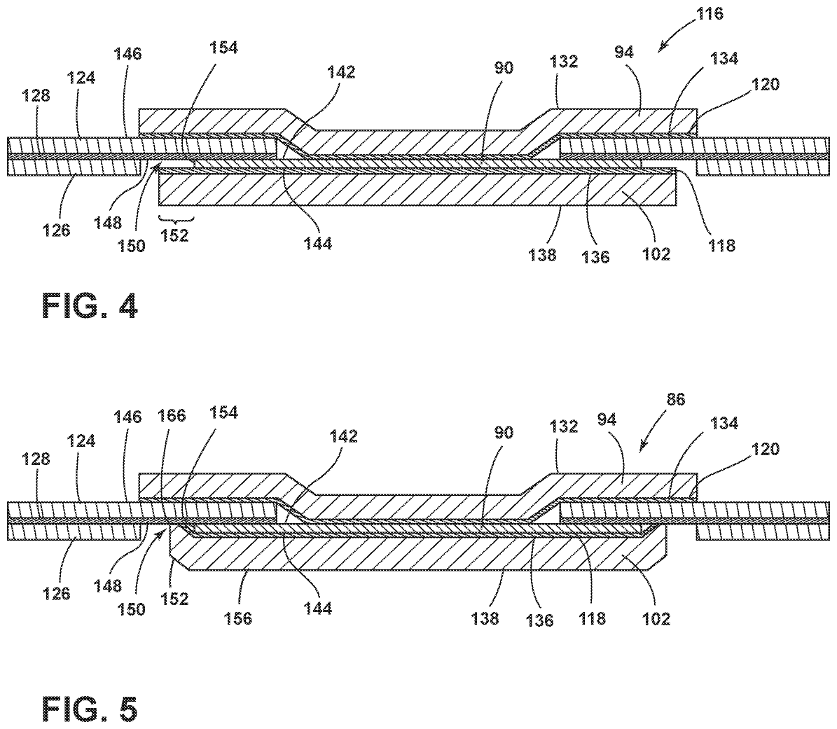

FIG. 4 schematically illustrates a cross-sectional view of the assembled MEA 116 in accordance with one non-limiting aspect of the present disclosure. The assembled MEA 116 may include the cathode GDE layer 102, the membrane 90, the subgasket 114, and the anode GDE layer 94. The cathode GDE layer 102 may include a cathode catalyst layer 118, and the anode GDE layer 94 may include an anode catalyst layer 120. The subgasket 114 may be comprised of upper and lower portions 124, 126 held together with a bonding or other adhesive clement 128. This exemplary illustration of the assembled MEA 116 is shown for non-limiting purposes as the present disclosure fully contemplates the assembled MEA 116 including additional layers, components, etc., including less layers, components, etc. The anode GDE layer 94 may include an anode top face 132 and an anode bottom face 134, the cathode GDE layer 102 may include a cathode top face 136 and a cathode bottom face 138, the membrane 90 may include a membrane top face 142 and a membrane bottom face 144 with the membrane 90 bottom face attached to the cathode top face 136, and the subgasket 114 may include a subgasket top face 146 and a subgasket bottom face 148 with the subgasket bottom face 148 attached to the membrane top face 142 and the subgasket top face 146 attached to the anode bottom face 134. A separation 150 between the subgasket 114 and the cathode GDE layer 102 may result in a window forming between the membrane 90 and an exterior environment.

The cathode GDE layer 102 may include a side perimeter portion 152 proximate the window that overhangs or extends beyond a perimeter 154 of the membrane 90. The side perimeter portion 152 may surround an entire perimeter 154 of the membrane 90 between the subgasket bottom face 148 and the cathode top face 136. One non-limiting aspect of the present disclosure contemplates utilizing the side perimeter portion 152 to provide the protective barrier 88 for the membrane 90. Returning to FIG. 3, the protective barrier 88 may be provided by bending the side perimeter portion 152 upwardly relative to an inner portion 156 of the cathode GDE layer 102 such that the side perimeter portion 152 presses against the subgasket bottom face 148. A bending process 162 of the MEA manufacturing system 84 may include a tool or other process for bending the cathode GDE layer 102 in the contemplated manner to provide the protected MEA 86. The bending process 162 may include stamping, pressing, or otherwise physically forcing the side perimeter portion 152 to press against, and optionally seal with, the subgasket 114. The bending process 162 may optionally include heating elements or other processes, e.g., etching, etc., to facilitate bending the cathode GDE layer 102 and/or the use of adhesives, sealants, etc. to further assure a tight seal between the subgasket 114 and the cathode GDE layer 102.

FIG. 5 schematically illustrates a cross-sectional view of the protected MEA 86 in accordance with one non-limiting aspect of the present disclosure. The bending process 162 may be beneficial in pressing the side perimeter portion 152 of the GDE layer 102 against the subgasket 114, which may result in a slight gap 164 forming between an edge of the membrane 90 and a sealing interface 164 between the subgasket 114 and the cathode GDE layer 102. The protective barrier 88 may be used in this manner to thwart external contaminants from reaching the membrane 90 through the window 150 shown in FIG. 4. The removal of the membrane portion 108 and the bending of the cathode GDE layer 102 may result in the membrane 90 and the cathode GDE layer 102 having a slightly shorter or narrower profile relative to the removal and bending processes. This narrowing may be compensated for by shaping the membrane 90 and/or the cathode GDE layer 102 to be correspondingly larger or wider in anticipation of the narrowing. The resulting protective barrier 88 may be operable for avoiding or limiting Fe2+ ions and/or other external contaminants from entering or interacting with the membrane 90 in such a manner as to work against and potentially breakdown the chemical structure of the membrane 90 over time. The capability to provide the protective barrier 88, optionally using the cathode GDE layer 102 and a slight removal of a portion of the segment 110 of the membrane 90, may be beneficial in protecting the membrane 90 from external contaminants without having to add additional componentry, devices, etc. beyond that already included as part of the MEA.

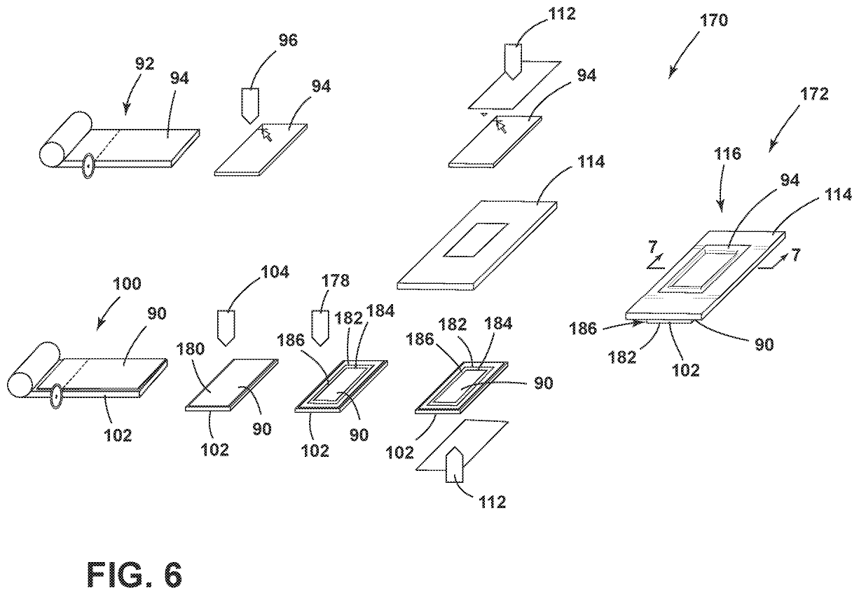

FIG. 6 schematically illustrates another MEA manufacturing system 170 in accordance with one non-limiting aspect of the present disclosure. The MEA manufacturing system 170 may be configured for manufacturing a MEA 172 with another type of protective barrier 174. The MEA manufacturing system 170 may include the anode spool 92, the cathode spool 100, the shaping tools 96, 104, and related processes described above. Once the anode GDE layer 94, the cathode GDE layer 102, and the membrane 90 may be cut to size, the MEA manufacturing system 170 may include a protective barrier tool 178 operable for executing a barrier protection process whereby the protective barrier 174 may be added. In the illustrated configuration, the protective barrier 174 may be added by removing a membrane portion 180 of the membrane 90, i.e., the protected barrier 174 may correspond with a portion of the cathode GDE layer 102 coinciding with the membrane portion 180 removed from the membrane 90. The protective barrier tool 178, for example, may be configured to support a laser ablation process, a die cutting process, or other removal process suitable for removing the membrane portion 180 from the membrane 90 adhered to the cathode GDE layer 102. The removing of the membrane portion 180 may result in the membrane 90 being divided into an outer membrane band 182 and an inner membrane portion 184, with the outer membrane band 182 surrounding the inner membrane portion 184 and being offset therefrom with a channel 186. The MEA manufacturing system 170 may include the assembly process 112 for assembling the cathode GDE layer 102, the membrane 90, a subgasket 114, and the anode GDE layer 94 together.

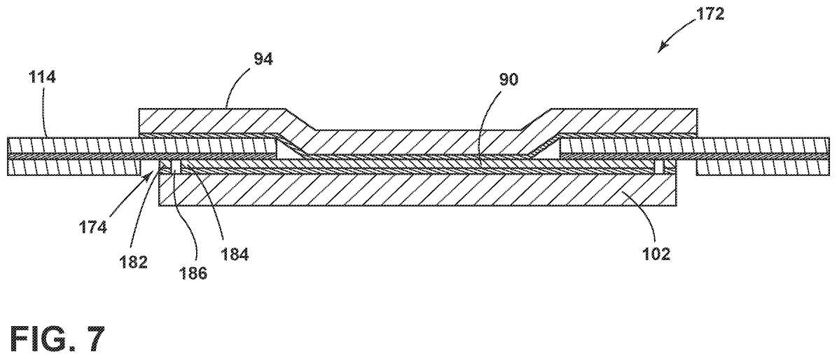

FIG. 7 schematically illustrates a cross-sectional view of the protected MEA 172 in accordance with one non-limiting aspect of the present disclosure. The MEA 172 may include the cathode GDE layer 102, the membrane 90, the subgasket 114, and the anode GDE layer 94. The use of the protective barrier 174 to provide the channel 186 between the outer membrane band 182 and the inner membrane portion 184 may result in the outer membrane band 182 operating as a sacrificial component. The outer membrane band 182 may be used in this manner to create a chemical reagent barrier 174 that may interact with external contaminants to prevent those contaminants from effectively reaching the inner membrane portion 184. The size, shape, width, of the outer membrane band 182 and/or the channel 186 may be a design parameter that varies depending on the material properties of the related components. While the present disclosure fully contemplates including additional sealants or materials to operate in cooperation with the protective barrier 174, the capability to provide the protective barrier 174 without the use of such additional features may be beneficial in enabling sorting external contaminants from reaching the membrane 90 without adding additional componentry, devices, etc. beyond that already included as part of the MEA 172. While the protective barrier 174 is described with respect to being shaped within the membrane 90 using a laser or a die cutting process, the present disclosure fully contemplates other mechanisms for generating the outer membrane 90 band, e.g., melting or deactivating the membrane 90 edge instead of complete ablation.

As supported above, the present disclosure relates to fabricating MEAs using lasers, such as femtosecond and nanosecond pulse lasers, or the like, which may include cutting the membrane layer without damage to the GDE underneath and thereafter cutting the remaining GDE at a position such that the cut edge of GDE layer extends beyond the cut edge of the membrane layer. The resultant layer structure combination of membrane and GDE may be further combined with a second GDE and laminated to form an MEA, with the resultant MEA having a superior resistance to chemical degradation of the membrane layer. The MEA may be constructed such that the outer edge of the membrane is protected by the GDE. The use of laser technology to selectively ablate the surface of the GDE and membrane at specific positions and depths may allow for different dimensional layer constructions without the need for additive assembly methods or complex cutting processes. In one aspect, a selective surface ablation at the edge of the GDE having the membrane may be performed to eliminate the pathway for contaminants, e.g., laser ablations to the depths of about 20 μm and a desired width may be performed. In another aspect, laser ablation may be used to remove the membrane under the subgasket and few microns away from the edge to form a trough like design. The present discloser may enable high volume manufacturing of MEAS with design features aimed at prolonging the durability of MEA, specifically the membrane life by limiting the pathway for life limiting contaminants reaching the membrane. The use of laser methods may reduce the cycle time needed to trim the part and incorporate design features necessary to prolong the MEA life, optionally avoiding complex fixturing and discrete assembly processes. This design and method may also enable high volume manufacturing of roll-to-roll laminated membrane and advanced coated membrane on electrode processes. The present disclosure may allow for process equipment to utilize more maintainable solutions that do not have significant maintenance cost, such as replacement or durability of a cutting method, e.g., a laser cutting may have much high precision and quality of part manufactured over time due there being less tooling to wear out.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All values of parameters (e.g., of quantities or conditions), unless otherwise indicated expressly or clearly in view of the context, including the appended claims, are to be understood as being modified in all instances by the term “about” whether or not “about” actually appears before the value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A protected membrane electrode assembly (MEA) for a fuel cell, comprising:
an anode gas diffusion electrode (GDE) layer having an anode top face and an anode bottom face;
a cathode GDE layer having a cathode top face and a cathode bottom face;
a membrane having a membrane top face and a membrane bottom face, with the membrane bottom face attached to the cathode top face;
a subgasket having a subgasket top face and a subgasket bottom face, with the subgasket bottom face attached to the membrane top face and the subgasket top face attached to the anode bottom face; and
a protective barrier configured for protecting the membrane against external contaminants, the protective barrier surrounding a perimeter of the membrane between the subgasket bottom face and the cathode top face.

2. The protected MEA according to claim 1, wherein:
a side perimeter portion of the cathode GDE layer forms at least a portion of the protective barrier.

3. The protected MEA according to claim 2, wherein:
the side perimeter portion is bent upwardly relative to an inner portion of the cathode GDE layer such that the side perimeter portion presses against the subgasket bottom face.

4. The protected MEA according to claim 3, wherein:
the side perimeter portion is formed by removing a segment of the membrane after the membrane has been attached to the cathode GDE layer.

5. The protected MEA according to claim 4, wherein:
the segment is removed from the membrane as part of a laser ablation process.

6. The protected MEA according to claim 4, wherein:
the segment is removed from the membrane as part of a die cutting process.

7. The protected MEA according to claim 1, wherein:
a side perimeter portion of the membrane forms at least a portion of the protective barrier.

8. The protected MEA according to claim 7, wherein:
the side perimeter portion corresponds with an outer band of the membrane offset with a channel from an inner portion of the membrane.

9. The protected MEA according to claim 8, wherein:
the channel is devoid of a material comprising the membrane.

10. The protected MEA according to claim 8, wherein:
the channel is formed by removing a segment of the membrane after the membrane has been attached to the cathode GDE layer.

11. The protected MEA according to claim 10, wherein:
the segment is removed from the membrane as part of a laser ablation process or a die cutting process.

12. A method for manufacturing a protected membrane electrode assembly (MEA) for a fuel cell, comprising:
receiving an anode gas diffusion electrode (GDE) layer having an anode top face and an anode bottom face;
receiving a cathode GDE layer having a cathode top face and a cathode bottom face;
receiving a membrane having a membrane top face and a membrane bottom face;
receiving a subgasket having a subgasket top face and a subgasket bottom face;
removing a membrane portion of the membrane to provide a protective barrier for protecting the membrane against external contaminant;
adhering the anode bottom face to the subgasket top face and the membrane top face; and
adhering the subgasket bottom face to the membrane top face such that the protective barrier surrounds a perimeter of the membrane between the subgasket bottom face and the cathode top face.

13. The method according to claim 12, further comprising:
providing the protective barrier based at least in part on bending a cathode portion of the cathode GDE layer coinciding with the membrane portion upwardly relative to an inner portion of the cathode GDE layer such that at least part of the cathode portion presses against the subgasket bottom face.

14. The method according to claim 12, further comprising:
providing the protective barrier based at least in part on removing the membrane portion such that the membrane is divided into an outer membrane band and an inner membrane portion, the outer membrane band surrounding the inner membrane portion and being offset therefrom with a channel.

15. The method according to claim 12, further comprising:
removing the membrane portion after the membrane bottom face has been adhered to the cathode top face.

16. The method according to claim 12, further comprising:
removing the membrane portion prior to the membrane bottom face being adhered to the cathode top face.

17. A protected membrane electrode assembly (MEA) for a fuel cell, comprising:
a first gas diffusion electrode (GDE) layer;
a second GDE layer;
a subgasket;
a membrane sandwiched between first and second GDE layers and at least a surrounding subgasket portion of the subgasket; and
a protective barrier configured for protecting the membrane against external contaminants, the protective barrier surrounding a perimeter of the membrane between the surrounding subgasket portion and the second GDE layer.

18. The protected MEA according to claim 17, wherein:
the protective barrier is formed with a bent portion of the second GDE layer.

19. The protected MEA according to claim 17, wherein:
the protective barrier is formed with a channel shaped to divided the membrane into an outer membrane band and an inner membrane portion.

20. The protected MEA according to claim 17, wherein:
the protective barrier is formed by removing a portion of the membrane.
